(19) United States
(12) Patent Application Publication
(10) Pub. No.: US 2008/0121330 A1
(43) Pub. Date: May 29, 2008

(54) RUBBER COMPOSITION

(75) Inventors: Wonmun Choi, Hiratsuka-shi (JP); Takashi Matsuda, Hiratsuka-shi (JP)

Correspondence Address: CONNOLLY BOVE LODGE & HUTZ LLP, 1875 EYE STREET, N.W., SUITE 1100, WASHINGTON, DC, 20036, US

(73) Assignee: The Yokohama Rubber Co., Ltd., Tokyo (JP)

(21) Appl. No.: 11/944,194

(22) Filed: Nov. 21, 2007

(30) Foreign Application Priority Data
Nov. 24, 2006 (JP) 2006-317331

(51) Int. Cl. B60C 9/00; C08J 3/24

(52) U.S. Cl. 152/537; 524/579

(57) ABSTRACT

A rubber composition containing (A) 100 parts by mass of a rubber component containing 30 parts by mass or more of a diene-based rubber, (B) 0.1 to 1.0 parts by mass of dithiosalicylic acid and (C) 0.05 to 0.5 part by mass, in terms of a metal content of an organic metal salt and a pneumatic tire using the same, whereby an alternative to DCBS exhibiting adhesion characteristics of rubber with steel cord equivalent to that of DCBS and capable of being applied to rubber for a belt cord and/or an edge cushion of a tire can be developed.

### TECHNICAL FIELD

The present invention relates to a rubber composition, more specifically relates to a rubber composition containing dithiosalicylic acid compounded thereto, as an alternative for N,N′-dicyclohexyl-1,3-benzothiazole-2-sulfenamide (DCBS) and suitable for use as a belt cord or a belt edge cushion or the like of a pneumatic tire.

### BACKGROUND ART

Slow-acting accelerators such as DCBS (DZ) have been used in the past as vulcanization accelerators for steel cord adhesive rubber compositions for pneumatic tires (e.g., see Ishikawa, Y.: Rubber Chem. Technol., 57, 855 (1984) and Van Ooij. W. J.: Rubber Chem. Technol., 52, 605 (1979)). However, DCBS was designated as a “Class I Monitored Chemical Substance” on Jan. 13, 2006, and therefore, in recent years, the development of vulcanization accelerators capable of providing adhesive characteristics to rubber with steel cord equivalent to DCBS and capable of being applied as an alternative to DCBS to the rubber for belt cords and the rubber for belt edge cushions is eagerly proceeded. However, alternatives to DCBS suitable for use for belt cords, belt edge cushions and the like, of pneumatic tires have not yet been developed. Among vulcanization accelerators, sulfenamide-based and thiazole-based vulcanization accelerators provide long scorch times and large adhesive power. On the other hand, it is said that thiuram-based vulcanization accelerators having the short scorch time make the vulcanization faster than the reaction with the copper at the steel cord surface, and, therefore, adhesion defects occur. Because of the above facts, DCBS, which provides a long scorch time even among the sulfonamide-based accelerators, is being used as a vulcanization accelerator of a steel cord adhesive rubber composition.

### DISCLOSURE OF THE INVENTION

Accordingly, an object of the present invention is to develop a vulcanization accelerator exhibiting adhesion characteristics of rubber with steel cord equivalent to DCBS and able to be applied to rubber for a belt cord and rubber for a belt edge cushion and the like of a tire as an alternative to DCBS.

In accordance with the present invention, there are provided a rubber composition comprising:

(A) 100 parts by mass of a rubber component containing 30 parts by mass or more of a diene-based rubber;

(B) 0.1 to 10 parts by mass of dithiosalicylic acid; and

(C) 0.05 to 0.5 part by mass, in terms of a metal content, of an organic metal salt and a pneumatic tire using the same as the rubber for a belt cord and/or for a belt edge cushion.

According to the present invention, by using as an alternative to the vulcanization accelerator DCBS a dithiosalicylic acid and an organic metal salt, and furthermore, optionally, a sulfenamide-based vulcanization accelerator in combination, it is possible to obtain adhesion characteristics of rubber with steel cord equal to or greater than those of DCBS.

### BEST MODE FOR CARRYING OUT THE INVENTION

The present inventors engaged in research, in order to solve the above-mentioned problem and, as a result, found that it is possible to use dithiosalicylic acid having the thiazole-based basic skeleton, as an alternative to the vulcanization accelerator DCBS for the adhesive formulation, whereby the present invention has been completed.

The rubber component compounded in the rubber composition of the present invention, as the component (A), contains natural rubbers (NR), polyisoprene rubbers (IR), various polybutadiene rubbers (BR), various styrene-butadiene copolymer rubbers (SBR), acrylonitrile-butadiene copolymer rubbers (NBR), hydrogenated NBR, chloroprene rubbers, ethylene-propylene-diene copolymer rubbers, or other diene-based rubbers in an amount of 30 parts by mass or more, preferably 50 parts by mass or more. When using the rubber composition of the present invention for the belt cord or the belt edge cushion of a tire, natural rubber (NR) and/or polyisoprene rubber (IR) is included in an amount of at least 30 parts by mass, preferably 50 parts by mass or more. If the amount of NR and/or IR is small, the strength is insufficient, and, therefore, the resultant rubber composition is not preferable for use as the belt cord and/or the belt edge cushion of a pneumatic tire.

The dithiosalicylic acid used, as the component (B), in the present invention is a known compound, which is commercially available and has the following structure:

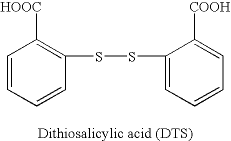

The amount of the dithiosalicylic acid is 0.1 to 10 parts by mass, preferably 0.2 to 5 parts by mass, more preferably 0.3 to 4.5 parts by mass, based upon 100 parts by mass of the rubber. If the amount of the dithiosalicylic acid is small, the adhesion between the rubber composition and the steel cord is insufficient, and, therefore, this is not desirable, while conversely if it is large, the vulcanization degree is increased too much, and, therefore, this is not desirable.

As the organic acid forming the organic metal salt (e.g., cobalt salt) used as the component (C) in the present invention, for example, neodecanoic acid, stearic acid, naphthenic acid, rosin acid, tall oil acid, palmitic acid, oleic acid, linoleic acid, linolenic acid, boron-containing organic acids such as borate neodecanoic acid and other cobalt salts, etc. can be mentioned. As a commercially available products, cobalt naphthenate (i.e., Co content: about 10%) made by Nippon Mining and Metals Co., Ltd., Manobond (Co content 22%) made by Rhodia Ltd., Nahsem cobalt (II) (Co content 16.54%) made by Nihon Kagaku Sangyo Co., Ltd., and the like can be used. If the amount of the organic cobalt salt is small, the adhesion with the steel cord is decreased and, therefore, this is not desirable, while conversely if it is large, the processability deteriorates, the physical properties of the vulcanized rubber are decreased, and the fatigue resistance becomes insufficient, and, therefore, this is not desirable.

In a preferred aspect of the present invention, in addition to the above components (A), (B) and (C), 0.1 to 5 parts by mass, more preferably 0.1 to 3 parts by mass, of a sulfenamide-based compound (D) based upon 100 parts by mass of the rubber component (A), is included. If the compounding amount is small, the vulcanization degree will not increase, and therefore, this is not desirable, while conversely if it is large, the vulcanization degree will increase too much, and, therefore, this is not desirable. The sulfenamide-based compounds (D) are commercially available and known compounds used for vulcanization accelerators and the like. As specific examples, N-cyclohexyl-1,3-benzothiazole-2-sulfenamide, N-tert-butyl-1,3-benzothiazole-2-sulfenamide, N-oxydiethylene-1,3-benzothiazole-2-sulfenamide and the like can be mentioned.

The rubber composition according to the present invention may include, in addition to the above components, carbon black, silica, and other reinforcing agent (fillers), vulcanizing or cross-linking agents, cross-linking accelerators, various oils, antioxidants, plasticizers and other various additives generally included for tire use and other rubber compositions. The additives are compounded by a general method to obtain a composition which can then be used for vulcanization or cross-linking. The amounts of these additives may be made the conventional general amounts so long as not adversely affecting the object of the present invention.

### EXAMPLES

Examples will now be illustrated to further explain the present invention, but the scope of the present invention is by no means limited to these Examples of course.

### Standard Example 1, Examples 1 to 2, and Comparative Examples 1-3

### Preparation of Sample

In each of the formulations shown in Table I, the ingredients, except for the vulcanization accelerator and the sulfur, were mixed in a 1.5 liter internal mixer for 7.5 minutes to obtain a master batch. The vulcanization accelerator and the sulfur were mixed into the master batch by an open roll to obtain the rubber composition.

Next, the rubber composition thus obtained was vulcanized in a 15×15×0.2 cm mold at 148° C. for 45 minutes to prepare a vulcanized rubber sheet, then the test methods shown below were used to determine the physical properties of the vulcanized rubber. The results are shown in Table I.

Test Methods for Evaluation of Physical Properties Tensile Test

100% modulus (M100), tensile strength at break (TB) and elongation at break (EB) were measured according to JIS K6251.

Wire ATSM (Blank, 100° C.×48 Hour Aging and Pressure Cooker (PC) Test)

Wire adhesion: Based on ATSM (D1871), brass-plated wire was embedded in the unvulcanized rubber and a pull-out test performed to obtain the pull out force (N) and the rubber coverage (%). The larger the pull-out force and the rubber coverage, the better the adhesiveness of the rubber with the wire is shown.

Adhesion after aging: An aged test piece (100° C., 48 hours) was used to perform the pull-out test and the pull-out force (N) and the rubber coverage (%) were used to evaluate the adhesion of the rubber with the wire.

Adhesion after pressure cooker test: A test piece tested in a pressure cooker tester under conditions of 130° C., 95% RH and 48 hours was used to perform a pull-out test and the pull-out force (N) and the rubber coverage (%) were used to evaluate the adhesion of the rubber with the wire.

TABLE I

| | Standard | | Comparative | | Comparative | Comparative |
|---|---|---|---|---|---|---|
| | Example 1 | Example 1 | Example 1 | Example 2 | Example 2 | Example 3 |
| Formulation (parts by mass) | | | | | | |
| NR*1 | 100 | 100 | 100 | 100 | 100 | 100 |
| CB*2 | 60 | 60 | 60 | 60 | 60 | 60 |
| Zinc oxide*3 | 9 | 9 | 9 | 9 | 9 | 9 |
| Stearic acid*4 | 1 | 1 | 1 | 1 | 1 | 1 |
| Antioxidant*5 | 2 | 2 | 2 | 2 | 2 | 2 |
| Cobalt salt*6 | 1 | 1 | 1 | 1 | 1 | 1 |
| Sulfur*7 | 6.5 | 6.5 | 6.5 | 6.5 | 6.5 | 6.5 |
| DCBS (DZ)*8 | 0.8 | — | — | — | — | — |
| BBS (NS)*9 | — | — | — | 0.3 | 0.3 | — |
| DTS*10 | — | 1.5 | — | 0.8 | — | — |
| DTP*11 | — | — | 1.5 | — | 0.8 | — |
| MBTS*12 | — | — | — | — | — | 1.5 |
| Automatic tensile strength | | | | | | |
| M100 (MPa) | 4.4 | 3.3 | 3.4 | 3.7 | 4.1 | 4.1 |
| TB (MPa) | 26.4 | 24.3 | 22.7 | 23.9 | 22.9 | 22.5 |
| EB (%) | 469 | 492 | 449 | 438 | 426 | 432 |
| Adhesive force test | | | | | | |
| Wire ATSM (BL) | | | | | | |
| A) Pull-out force | 1115 | 1120 | 1062 | 1130 | 1010 | 850 |
| A) Rubber adhesion | 88 | 87 | 85 | 88 | 86 | 83 |
| Wire ATSM | | | | | | |
| (100° C. × 48 hr aging) | | | | | | |
| A) Pull-out force | 959 | 910 | 400 | 929 | 670 | 720 |
| A) Rubber adhesion | 93 | 87 | 55 | 93 | 75 | 79 |
| Wire ATSM (PC) | | | | | | |
| A) Pull-out force | 771 | 760 | 627 | 780 | 645 | 325 |
| A) Rubber coverage | 69 | 87 | 83 | 85 | 84 | 15 |

Notes of Table I
*1: Natural rubber (RSS#3)
*2: Seast 30 made by Tokai Carbon Co., Ltd.
*3: Zinc oxide (Ginrei R) made by Toho Zinc Co., Ltd.
*4: Beads Stearic Acid YR made by NOF Corporation.
*5: SANTOFLEX 6PPD made by FLEXSYS.
*6: Manobond C225 (Co content 22.5%) made by Rhodia.
*7: Crystex HS OT 20 made by Azko Nobel.
*8: Nocceler DZ-G made by Ouchi Shinko Chemical Industrial Co., Ltd.
*9: Nocceler NS-P made by Ouchi Shinko Chemical Industrial Co., Ltd.
*10: Dithiosalicylic acid made by Kanto Chemical Co. Inc.

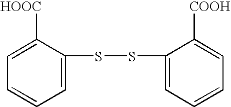

*11: Dithiodipropionic acid made by Kanto Chemical Co. Inc.

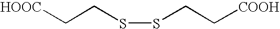

Dithiodipropionic acid (DTP)
*12: 2-benzothiazyl disulfide made by Ouchi Shinko Chemical Industrial Co., Ltd.

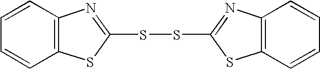

### INDUSTRIAL APPLICABILITY

As explained above, compared to dithiodipropionic acid-based vulcanization accelerator (see Comparative Examples 1 and 2) and benzothiazyl disulfide-based vulcanization accelerator (Comparative Example 3), when using the dithiosalicylic acid and the organic metal salt according to the present invention (Examples 1 and 2), there is a sufficient initial adhesion with wire and heat resistant wire adhesion after aging, the wire adhesion after the pressure cooker (PC) test is superior, and use at locations where a high adhesion and durability are required such as the belt cord or belt edge cushion of a pneumatic tire can be withstood, and, therefore, use as an alternative to the conventionally used DCBS is possible.

1. A rubber composition comprising:
(A) 100 parts by mass of a rubber component containing 30 parts by mass or more of diene-based rubber;
(B) 0.1 to 10 parts by mass of dithiosalicylic acid; and
(C) 0.05 to 0.5 part by mass, in terms of a metal content, of an organic metal salt.

2. A rubber composition as claimed in claim 1 further comprising 0.1 to 5 parts by mass of a sulfenamide-based compound.

3. A pneumatic tire using a rubber composition according to claim 1 as a rubber for a belt cord and/or for a belt edge cushion.

4. A pneumatic tire using a rubber composition according to claim 2 as a rubber for a belt cord and/or for a belt edge cushion.
